(19) United States
(12) Patent Application Publication
(10) Pub. No.: US 2008/0143479 A1
(43) Pub. Date: Jun. 19, 2008

(54) Digital Device Being Worked with Exterior Power Supply and Control Method Thereof

(76) Inventor: Gab Sik Kim, Seoul (KR)

Correspondence Address: IPHORGAN, LTD., 1130 LAKE COOK ROAD, SUITE 240, BUFFALO GROVE, IL, 60089, US

(21) Appl. No.: 11/883,872

(22) PCT Filed: Feb. 27, 2006
(86) PCT No.: PCT/KR2006/000673

§ 371 Date: Aug. 7, 2007

(30) Foreign Application Priority Data
Feb. 28, 2005 (KR) 10-2005-0016951

(51) Int. Cl. E05B 49/00

(52) U.S. Cl. 340/5.65

(57) ABSTRACT

Disclosed are a digital apparatus operating using external power and a method for controlling the digital apparatus. The digital apparatus includes a power supply for supplying power, a one-wire interface for determining if an input signal is a reset signal, a ready signal, a read signal or a write signal, the one-wire interface being connected to the power supply, an oscillator for providing a clock signal to the one-wire interface, a controller for performing a reset operation, a ready operation, a read operation or a write operation according to determination results of the one-wire interface, a RAM and a ROM for storing data, a timer for providing time information, and a RNG for encrypting data.

### TECHNICAL FIELD

The present invention relates to a digital apparatus field, and more particularly to a digital apparatus operating using external power and a method for controlling the digital apparatus, which can enhance the speed and the efficiency of a system by providing a bi-directional communication function, a processing function, an authentication function, etc., between a master device and a slave device, and at the same time by efficiently defining a ready packet signal, a read packet signal, a write packet signal, etc.

### BACKGROUND ART

An electronic locking system has been widely used with the recognition that it has stability relatively higher than that of a mechanical locking system. The electronic locking system includes a contact-type electronic locking system, a key input-type electronic locking system, a wireless-type electronic locking system, etc. In the contact-type electronic locking system, a password code is automatically input by means of a key having the password code therein, so that a lock is unlocked and a door can be opened. In the key input-type electronic locking system provided with a keypad, a user inputs a password through the keypad after a door is locked, so that a lock is unlocked and the door can be opened. In the wireless-type electronic locking system, power is wirelessly supplied from a lock to a key and a password code is outputted from the key, so that a lock is unlocked and the door can be opened.

According to the contact-type electronic locking system, if a key having a password therein is inserted into a lock, an internal chip of the key operates with the supply of power from the lock to the key, and the password is transferred to the lock from the internal chip of the key. Then, when the password is correct, the lock is unlocked.

A digital apparatus, which receives external power and outputs ID values, such as a DS2401 manufactured by a Dallas Semiconductor, Inc., is used as a chip, which operates based on power supplied from an external (e.g. lock), as in the case of the contact-type electronic locking system as described above.

However, the conventional digital apparatus, which receives external power and outputs ID values, such as a DS2401 manufactured by a Dallas Semiconductor, Inc., corresponds to a one-way apparatus that simply outputs only stored ID values. That is, the conventional digital apparatus does not provide a bi-directional communication function.

Further, since the conventional digital apparatus, which receives external power and outputs ID values, such as a DS2401 manufactured by a Dallas Semiconductor, Inc., does not provide the bi-directional communication function, it also does not provide a process function.

Furthermore, since the conventional digital apparatus, which receives external power and outputs ID values, such as a DS2401 manufactured by a Dallas Semiconductor, Inc., does not provide the process function, it also does not provide an authentication function.

### DISCLOSURE OF THE INVENTION

Therefore, the present invention has been made in view of the above-mentioned problems, and it is an object of the present invention to provide a digital apparatus operating using external power and a method for controlling the digital apparatus, which can enhance the speed and the efficiency of a system by providing a bi-directional communication function, a processing function, an authentication function, etc., between a master device and a slave device, and at the same time by efficiently defining a ready packet signal, a read packet signal, a write packet signal, etc.

According to one aspect of the present invention, there is provided a digital apparatus operating using external power, the digital apparatus including: a power supply for supplying power; a one-wire interface for determining if an input signal is a reset signal, a ready signal, a read signal or a write signal, the one-wire interface being connected to the power supply; an oscillator for providing a clock signal to the one-wire interface; a controller for performing a reset operation, a ready operation, a read operation or a write operation according to determination results of the one-wire interface; a Random Access Memory (RAM) and a Read Only Memory (ROM) for storing data; a timer for providing time information; and a RNG for encrypting data.

Preferably, the digital apparatus further includes a chip program-writing interface installed within the digital apparatus in order to enable external data to be written in the memory.

According to another aspect of the present invention, there is provided a method for controlling a digital apparatus operating using external power, the method comprising a step of determining if an input signal is a reset packet signal, a ready packet signal, a read packet signal or a write packet signal when an operation starts, wherein timing of the reset packet signal includes a reset interval in a low state, a hold interval in a high state, and a response interval in a low state, timing of the ready packet signal includes a request interval in a low state, a hold interval in a high state, ready response data, and a data processing interval, timing of the read packet signal includes a request interval in a low state, a hold interval in a high state, a data interval, and a data processing interval, and timing of the write packet signal includes a request interval in a low state, a hold interval in a high state, a data interval, and a data processing interval.

Preferably, in the reset packet signal, time T_{RESET} of the reset interval is greater than or equal to 4T_{UNIT}, response start time T_{RACK}_{_{—}}_{START} is less than or equal to (T_{UNIT}+T_{CLOCK}), and response end time T_{RACK}_{_{—}}_{END} is greater than or equal to (2T_{UNIT}+T_{CLOCK}), and is less than or equal to 3T_{UNIT}.

Preferably, in the ready packet signal, time T_{REQ} of the request interval is greater than or equal to (T_{UNIT}−T_{CLOCK}), and is less than or equal to T_{UNIT}, ready start time T_{READY}_{_{—}}_{START} is less than or equal to (T_{UNIT}+T_{CLOCK}), ready end time T_{READY}_{_{—}}_{END} is greater than or equal to (2T_{UNIT}+T_{CLOCK}), and is less than or equal to 3T_{UNIT}, and ready interval time T_{READY}_{_{—}}_{BIT}_{_{—}}_{INTV} is greater than or equal to 10T_{UNIT}.

Preferably, the read packet signal, time T_{REQ} of the request interval is greater than or equal to (T_{UNIT}−T_{CLOCK}), and is less than or equal to T_{UNIT}, read start time T_{READ}_{_{—}}_{START} is less than or equal to (T_{UNIT}+T_{CLOCK}), read end time T_{READ}_{_{—}}_{END} is greater than or equal to (2T_{UNIT}+T_{CLOCK}), and is less than or equal to 3T_{UNIT}, read bit interval time T_{READ}_{_{—}}_{BIT}_{_{—}}_{INTV} is greater than or equal to 6T_{UNIT}, and read byte interval time T_{READ}_{_{—}}_{BYTE}_{_{—}}_{INTV} is greater than or equal to 2T_{UNIT}.

Preferably, in the write packet signal, time T_{REQ} of the request interval is greater than or equal to (T_{UNIT}−T_{CLOCK}), and is less than or equal to T_{UNIT}, write start time T_{WRITE}_{_{—}}_{START} is less than or equal to (T_{UNIT}+T_{CLOCK}), write end time T_{WRITE}_{_{—}}_{END} is greater than or equal to (2T_{UNIT}+T_{CLOCK}), and is less than or equal to 3T_{UNIT}, write bit interval time T_{WRITE}_{_{—}}_{BIT}_{_{—}}_{INTV} is greater than or equal to 6T_{UNIT}, and write byte interval time T_{WRITE}_{_{—}}_{BYTE}_{_{—}}_{INTV} is greater than or equal to 2T_{UNIT}.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating a digital apparatus operating using external power according to one embodiment of the present invention;

FIG. 2 is a circuit diagram illustrating a power supply of a digital apparatus operating using external power according to one embodiment of the present invention;

FIG. 3 is a block diagram illustrating a one-wire interface of a digital apparatus operating using external power according to one embodiment of the present invention;

FIG. 4 is a timing diagram illustrating a reset packet signal of a digital apparatus operating using external power according to one embodiment of the present invention;

FIG. 5 is a timing diagram illustrating a ready packet signal of a digital apparatus operating using external power according to one embodiment of the present invention;

FIG. 6 is a timing diagram illustrating a read packet signal of a digital apparatus operating using external power according to one embodiment of the present invention;

FIG. 7 is a timing diagram illustrating a write packet signal of a digital apparatus operating using external power according to one embodiment of the present invention;

FIG. 8 is a flow diagram illustrating a method for controlling the digital apparatus operating using external power according to one embodiment of the present invention.

### BEST MODE FOR CARRYING OUT THE INVENTION

A preferred embodiment of the present invention will be described with reference to the accompanying drawings.

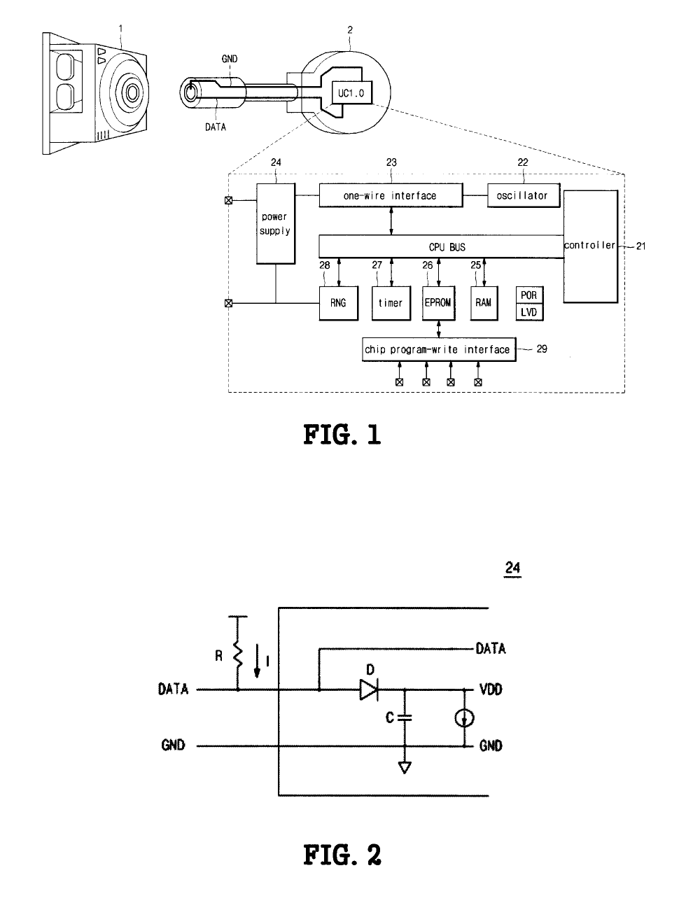

FIG. 1 is a block diagram illustrating a digital apparatus operating using external power according to one embodiment of the present invention. As illustrated in FIG. 1, the digital apparatus operating using external power according to one embodiment of the present invention includes a power supply 24 for supplying power, a one-wire interface 23, an oscillator 22, a controller 21, a Random Access Memory (hereinafter, referred to as RAM) 25 and a Read Only Memory (ROM) 26 for storing data, a timer 27 for providing time information, a RNG 28 for encrypting data, and a chip program-writing interface 29. The one-wire interface 23 is connected to the power supply 24, and determines if an input signal is a reset signal, a ready signal, a read signal, or a write signal. The oscillator 22 provides a clock signal to the one-wire interface 23. The controller 21 performs a reset operation, a ready operation, a read operation or a write operation according to the determination results of the one-wire interface 23. The chip program-writing interface 29 is installed within the digital apparatus so that external data can be written in the memory.

FIG. 2 is a circuit diagram illustrating the power supply 24 of the digital apparatus operating using external power according to one embodiment of the present invention. As illustrated in FIG. 2, the power supply 24 of the digital apparatus operating using external power according to one embodiment of the present invention includes a pull-up resistor R, a rectifier diode D to which a data signal line DATA is connected forward, and a smoothing capacitor C connected between the cathode of the rectifier diode D and the ground GND.

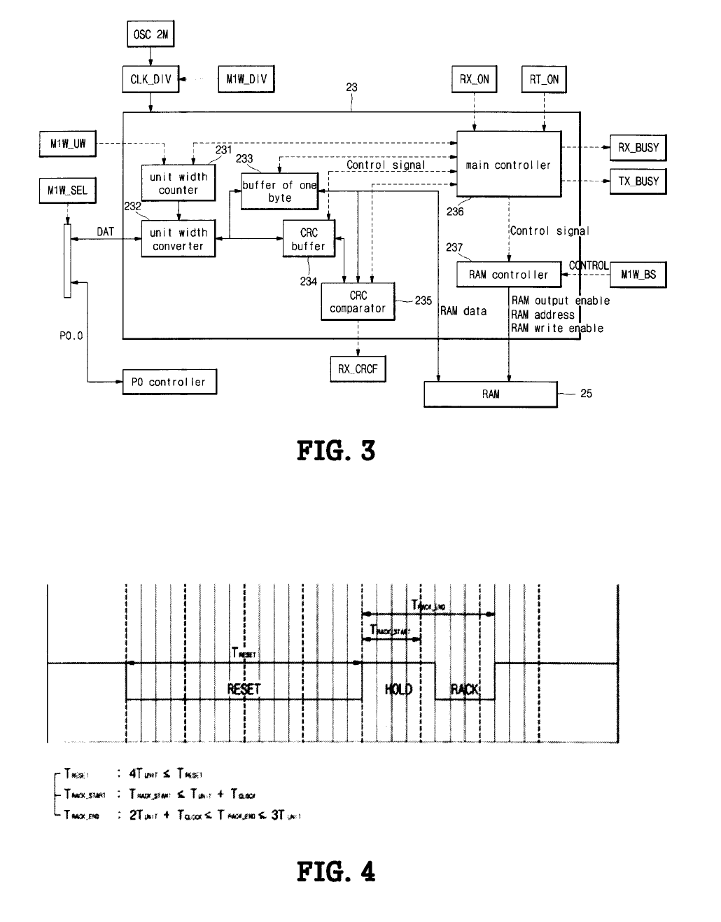

FIG. 3 is a block diagram illustrating the one-wire interface 23 of the digital apparatus operating using external power according to one embodiment of the present invention. As illustrated in FIG. 3, the one-wire interface 23 of the digital apparatus operating using external power according to one embodiment of the present invention includes a unit width counter 231 for controlling the width of an input signal, a unit width converter 232 for adjusting the width of the input signal, a buffer 233 of one byte for storing input signal data of one byte, a CRC buffer 234 for storing the CRC of the input signal, a CRC comparator 235 for comparison of the CRC, a main controller 236, and a RAM controller 237 for controlling the RAM 25. The main controller 236 determines if the input signal is a reset signal, a ready signal, a read signal or a write signal.

FIG. 8 is a flow diagram illustrating a method for controlling the digital apparatus operating using external power according to one embodiment of the present invention. As illustrated in FIG. 8, the method for controlling the digital apparatus operating using external power according to one embodiment of the present invention includes steps 10, 20, 30 and 40. In step 10, the digital apparatus starts its operation. In step 20, the digital apparatus determines if the input signal is a reset packet signal. In step 30, when the input signal is not the reset packet signal, the digital apparatus determines if the input signal is a ready packet signal. In step 40, when the input signal is not the ready packet signal, the digital apparatus determines if the input signal is a read packet signal or a write packet signal.

Hereinafter, the digital apparatus having the construction as described above and the method for controlling the digital apparatus according to one embodiment of the present invention will be described in detail.

If the lock 1 is combined with the key 2, as in the case of the contact-type electronic locking system, power is supplied to the power supply 24 from the lock 1 through the data signal line DATA.

The power supply 24 rectifies the power supplied from the lock 1 by means of the diode D, smoothes the rectified power by means of the smoothing capacitor C, and supplies the smoothed power to each element in the apparatus.

If the digital apparatus starts to operate using the power rectified and smoothed by the power supply 24 (S10), a signal inputted through the data signal line DATA is transmitted to the buffer 233 of one byte via the unit width converter 232 of the one-wire interface 23. Accordingly, data of one byte is buffered in the buffer 233 of one byte, and then are transferred to the main controller 236.

The main controller 236 of the one-wire interface 23 determines if the input data of one byte is a reset packet signal (S20).

The reset packet signal has a timing configuration as illustrated in FIG. 4, i.e. a reset interval RESET in a low state, a hold interval HOLD in a high state, and a response interval RACK in a low state. Herein, the time T_{RESET} of the reset interval RESET is greater than or equal to 4T_{UNIT}, the response start time T_{RACK}_{_{—}}_{START} is less than or equal to (T_{UNIT}+T_{CLOCK}), and the response end time T_{RACK}_{_{—}}_{END} is greater than or equal to (2T_{UNIT}+T_{CLOCK}), and is less than or equal to 3T_{UNIT}.

When the input signal is the reset packet signal, the main controller 236 of the one-wire interface 23 informs the controller 21 of reception of the reset packet signal.

However, when the input signal is not the reset packet signal, the main controller 236 of the one-wire interface 23 determines if the input signal is a ready packet signal (S30).

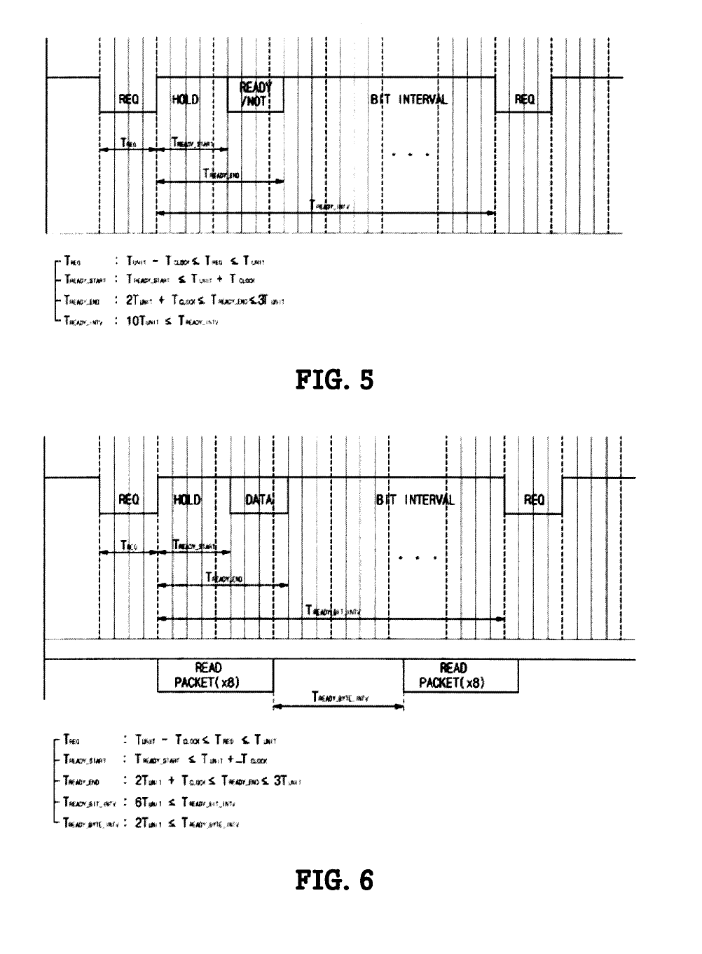

The ready packet signal has a timing configuration as illustrated in FIG. 5, i.e. a request interval REQ in a low state, a hold interval HOLD in a high state, ready response data READY, and a data processing interval BIT INTERVAL. Herein, the time T_{RESET} of the request interval REQ is greater than or equal to (T_{UNIT}−T_{CLOCK}), and is less than or equal to T_{UNIT}. The ready start time T_{READY}_{_{—}}_{START} is less than or equal to (T_{UNIT}+T_{CLOCK}), and the ready end time T_{READY}_{_{—}}_{END} is greater than or equal to (2T_{UNIT}+T_{CLOCK}), and is less than or equal to 3T_{UNIT}. The ready interval time T_{READY}_{_{—}}_{BIT}_{_{—}}_{INTV} is greater than or equal to 10T_{UNIT}.

When the input signal is the ready packet signal, if there exists data to be transmitted from a slave device to a master device or it is ready to receive data, the main controller 236 of the one-wire interface 23 causes the ready response data READY to be in a low state. However, if there exist no data to be transmitted from the slave device to the master device or it is not ready to receive data, the main controller 236 of the one-wire interface 23 causes the ready response data READY to be in a high state. In this way, the main controller 236 transmits the input signal to the controller 21 that is a master device.

In the meantime, when the input signal is not the ready packet signal, the main controller 236 of the one-wire interface 23 determines if the input signal is a read packet signal or a write packet signal (S40).

The read packet signal has a timing configuration as illustrated in FIG. 6, i.e. a request interval REQ in a low state, a hold interval HOLD in a high state, a data interval DATA, and a data processing interval BIT INTERVAL. Herein, the time T_{RESET} of the request interval REQ is greater than or equal to (T_{UNIT}−T_{CLOCK}), and is less than or equal to T_{UNIT}. The read start time T_{READ}_{_{—}}_{START} is less than or equal to (T_{UNIT}+T_{CLOCK}), and the read end time T_{READ}_{_{—}}_{END} is greater than or equal to (2T_{UNIT}+T_{CLOCK}), and is less than or equal to 3T_{UNIT}. The read bit interval time T_{READ}_{_{—}}_{BIT}_{_{—}}_{INTV} is greater than or equal to 6T_{UNIT}, and the read byte interval time T_{READ}_{_{—}}_{BYTE}_{_{—}}_{INTV} is greater than or equal to 2T_{UNIT}.

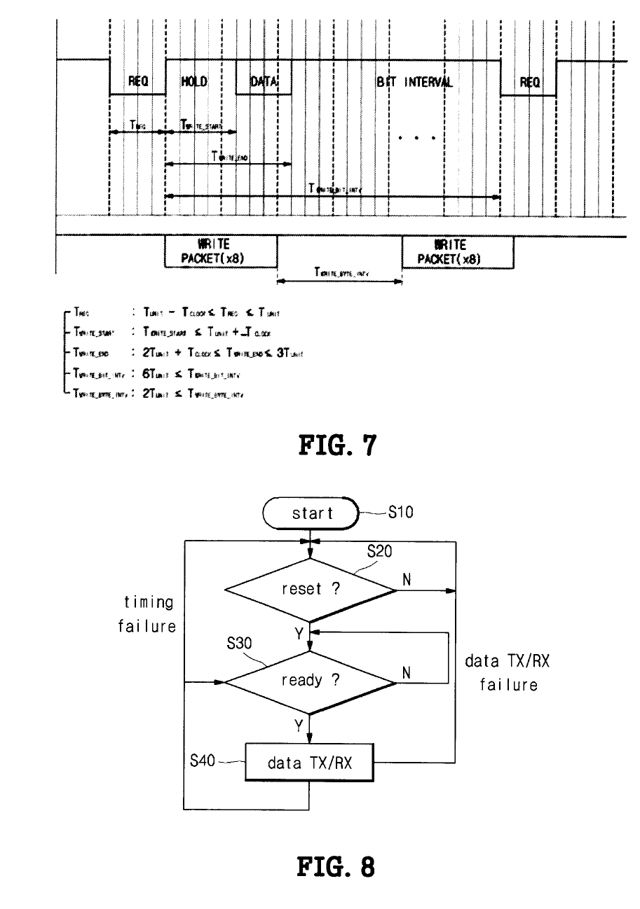

The write packet signal has a timing configuration as illustrated in FIG. 7, i.e. a request interval REQ in a low state, a hold interval HOLD in a high state, a data interval DATA, and a data processing interval BIT INTERVAL. Herein, the time T_{RESET} of the request interval REQ is greater than or equal to (T_{UNIT}−T_{CLOCK}), and is less than or equal to T_{UNIT}. The write start time T_{WRITE}_{_{—}}_{START} is less than or equal to (T_{UNIT}+T_{CLOCK}), and the write end time T_{WRITE}_{_{—}}_{END} is greater than or equal to (2T_{UNIT}+T_{CLOCK}), and is less than or equal to 3T_{UNIT}. The write bit interval time T_{WRITE}_{_{—}}_{BIT}_{_{—}}_{INTV} is greater than or equal to 6T_{UNIT}, and the write byte interval time T_{WRITE}_{_{—}}_{BYTE}_{_{—}}_{INTV} is greater than or equal to 2T_{UNIT}.

When the input signal is the read packet signal or the write packet signal, the main controller 236 of the one-wire interface 23 informs the controller 21 of reception of the read packet signal or the write packet signal.

As described above, the main controller 236 of the one-wire interface 23 determines if the input signal is the reset signal, the ready signal, the read signal or the write signal, and then transmits the input signal to the controller 21. Accordingly, the controller 21 performs a processing function, such as a reset operation, a ready operation, a read operation or a write operation, according to the signal inputted from the main controller 236.

In the process of performing the read operation and the write operation, the controller 21 performs bi-directional communication with the digital apparatuses of the lock 1 through the one-wire data signal line DATA, i.e. bi-directional communication is performed between the master device and the slave device. Further, the controller 21 can also authenticate the lock 1 by means of authentication data through the communication function as described above.

In the meantime, a user can write external data and commands in the internal memory of the digital apparatus by means of the chip program-writing interface 29 installed in the digital apparatus.

### INDUSTRIAL APPLICABILITY

As can be seen from the foregoing, according to the present invention, it is possible to enhance the speed and the efficiency of a system by providing a bi-directional communication function, a processing function, an authentication function, etc., between a master device and a slave device, and at the same time by efficiently defining a ready packet signal, a read packet signal, a write packet signal, etc.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A digital apparatus operating using external power, the digital apparatus comprising:
a power supply for supplying power;
a one-wire interface for determining if an input signal is a reset signal, a ready signal, a read signal or a write signal, the one-wire interface being connected to the power supply;
an oscillator for providing a clock signal to the one-wire interface;
a controller for performing a reset operation, a ready operation, a read operation or a write operation according to determination results of the one-wire interface;
a Random Access Memory (RAM) and a Read Only Memory (ROM) for storing data;
a timer for providing time information; and
a RNG for encrypting data.

2. The digital apparatus according to claim 1, further comprising a chip program-writing interface installed within the digital apparatus in order to enable external data to be written in the memory.

3. The digital apparatus according to claim 1 or 2, wherein the power supply comprises:
a pull-up resistor;
a rectifier diode to which a data signal line is connected forward; and
a smoothing capacitor connected between a cathode of the rectifier diode and a ground.

4. The digital apparatus according to claim 1 or 2, wherein the one-wire interface comprises:
a unit width counter for controlling a width of the input signal;
a unit width converter for adjusting the width of the input signal;
a buffer of one byte for storing input signal data of one byte;
a CRC buffer for storing a CRC of the input signal;
a CRC comparator for comparison of the CRC;
a main controller for determining if the input signal is the reset signal, the ready signal, the read signal or the write signal; and
a RAM controller for controlling the RAM.

5. A method for controlling a digital apparatus operating using external power, the method comprising a step of determining if an input signal is a reset packet signal, a ready packet signal, a read packet signal or a write packet signal when an operation starts,
wherein timing of the reset packet signal includes a reset interval in a low state, a hold interval in a high state, and a response interval in a low state, timing of the ready packet signal includes a request interval in a low state, a hold interval in a high state, ready response data, and a data processing interval, timing of the read packet signal includes a request interval in a low state, a hold interval in a high state, a data interval, and a data processing interval, and timing of the write packet signal includes a request interval in a low state, a hold interval in a high state, a data interval, and a data processing interval.

6. The method according to claim 5, wherein, in the reset packet signal, time T_{RESET} of the reset interval is greater than or equal to 4T_{UNIT}, response start time T_{RACK}_{_{—}}_{START} is less than or equal to (T_{UNIT}+T_{CLOCK}), and response end time T_{RACK}_{_{—}}_{END} is greater than or equal to (2T_{UNIT}+T_{CLOCK}), and is less than or equal to 3T_{UNIT}.

7. The method according to claim 5, wherein, in the ready packet signal, time T_{REQ} of the request interval is greater than or equal to (T_{UNIT}−T_{CLOCK}), and is less than or equal to T_{UNIT}, ready start time T_{READY}_{_{—}}_{START} is less than or equal to (T_{UNIT}+T_{CLOCK}), ready end time T_{READY}_{_{—}}_{END} is greater than or equal to (2T_{UNIT}+T_{CLOCK}), and is less than or equal to 3T_{UNIT}, and ready interval time T_{READY}_{_{—}}_{BIT}_{_{—}}_{INTV} is greater than or equal to 10T_{UNIT}.

8. The method according to claim 5, wherein, the read packet signal, time T_{REQ} of the request interval is greater than or equal to (T_{UNIT}−T_{CLOCK}), and is less than or equal to T_{UNIT}, read start time T_{READ}_{_{—}}_{START} is less than or equal to (T_{UNIT}+T_{CLOCK}), read end time T_{READ}_{_{—}}_{END} is greater than or equal to (2T_{UNIT}+T_{CLOCK}), and is less than or equal to 3T_{UNIT}, read bit interval time T_{READ}_{_{—}}_{BIT}_{_{—}}_{INTV} is greater than or equal to 6T_{UNIT}, and read byte interval time T_{READ}_{_{—}}_{BYTE}_{_{—}}_{INTV} is greater than or equal to 2T_{UNIT}.

9. The method according to claim 5, wherein, in the write packet signal, time T_{REQ} of the request interval is greater than or equal to (T_{UNIT}−T_{CLOCK}), and is less than or equal to T_{UNIT}, write start time T_{WRITE}_{_{—}}_{START} is less than or equal to (T_{UNIT}+T_{CLOCK}), write end time T_{WRITE}_{_{—}}_{END} is greater than or equal to (2T_{UNIT}+T_{CLOCK}), and is less than or equal to 3T_{UNIT}, write bit interval time T_{WRITE}_{_{—}}_{BIT}_{_{—}}_{INTV} is greater than or equal to 6T_{UNIT}, and write byte interval time T_{WRITE}_{_{—}}_{BYTE}_{_{—}}_{INTV} is greater than or equal to 2T_{UNIT}.
